(19) United States
(12) Patent Application Publication
(10) Pub. No.: US 2012/0217675 A1
(43) Pub. Date: Aug. 30, 2012

(54) IMPRINT APPARATUS AND ARTICLE MANUFACTURING METHOD

(75) Inventor: Yoshiyuki USUI, Utsunomiya-shi (JP)

(73) Assignee: CANON KABUSHIKI KAISHA, Tokyo (JP)

(21) Appl. No.: 13/371,552

(22) Filed: Feb. 13, 2012

(30) Foreign Application Priority Data
Feb. 25, 2011 (JP) 2011-040840

(51) Int. Cl. B29C 59/02

(52) U.S. Cl. 264/293; 425/150

(57) ABSTRACT

An imprint apparatus comprises: a first scope configured to measure a position deviation amount between a shot region and an original; and a controller. The controller brings the original into contact with the resin coated on each of not less than two shot regions of plural shot regions, which is aligned based on preobtained layout data, and measures a position deviation amount between each of the not less than two shot regions and the original using the first scope, calculates a position deviation amount between each of the plural shot regions and the original statistically processing the measured position deviation amounts, and corrects the layout data of the plural shot regions using the calculated position deviation amounts, and executes the imprint process while aligning each shot region other than the not less than two shot regions with the original based on the corrected layout data.

### BACKGROUND OF THE INVENTION

1. Field of the Invention

The present invention relates to an imprint apparatus and a method of manufacturing an article.

2. Description of the Related Art

Recently, micropatterning of semiconductor devices has advanced, and imprint techniques by which a substrate is coated with a resin (a resin is dispensed on a substrate) and the resin is cured while an original is pressed against the resin are beginning to be used as semiconductor device manufacturing methods. A photo-curing method is one of these imprint techniques. In an imprint apparatus using the photo-curing method, a pattern formation region (to be referred to as a shot region hereinafter) on a substrate is first coated with a photo-curing resin. Then, a mechanism for holding and driving an original performs alignment correction for the substrate and original. After that, the original is pressed against the resin. The resin is cured by ultraviolet irradiation, and the original is released. Consequently, a pattern of the resin is formed on the substrate.

An imprint apparatus using the photo-curing method described in Japanese Patent No. 4185941 adopts a die-by-die method to measure a position shift between a pattern already formed on a substrate and an original. In the die-by-die method, when pressing an original against each shot region, marks formed on the substrate and original are simultaneously observed using a measurement scope, thereby measuring a position deviation amount and correcting the relative positions of the substrate and original. However, the die-by-die method cannot detect a mark position shift caused by a process factor such as the decrease in film thickness of an underlayer, and hence is sometimes unable to correctly perform alignment.

By contrast, a global alignment method is most frequently used in a conventional exposure apparatus using a photolithography technique of transferring an original pattern onto a substrate by using a projection optical system. In the global alignment method, marks in a few representative shot regions (to be referred to as sample shots hereinafter) are measured, and a statistical process is performed based on the measurement results, thereby obtaining a global correction value. Based on this global correction value, alignment is performed on all shot regions by using the same index. Since alignment is performed by the same index in the global alignment method, the quality of all shot regions of a wafer can be checked by performing a sampling test on a few shot regions in a post-process, and this increases the productivity. Also, the influence of an abnormal mark shift caused by a process factor can be avoided by properly selecting sample shots. This increases the stability of the overlay precision. Japanese Patent Laid-Open No. 2005-108975 describes an imprint apparatus for measuring a position shift between an original and wafer at a distance of 30 μm by using a TTM (Through The Mask) scope. Japanese Patent Laid-Open No. 2005-108975 describes that the original and wafer can be aligned by using either the die-by-die alignment method or global alignment method.

As in the conventional exposure apparatus, correction by the global alignment method is presumably useful in the imprint apparatus as well, in order to avoid the influence of an abnormal mark shift caused by a process factor. In the imprint apparatus described in Japanese Patent Laid-Open No. 2005-108975, however, when measuring the positions of sample shots by using a TTM scope, an original is spaced apart from a substrate by a distance of 30 μm, that is, the original is not pressed against the substrate. On the other hand, when performing an imprint process, an original is pressed against a substrate with a resin being sandwiched between them. That is, the Z-direction relative positional relationship between a substrate and original during sample shot position measurement differs from that during the imprint process. If the Z-direction relative positions of a substrate and original change, a position shift of the original or a TTM scope measurement error occurs in accordance with the change amount. For example, even when alignment correction is performed on a substrate and original based on values measured by a TTM scope while the original is not in contact with the substrate, if a driving error occurs when driving an original holder, position shifts occur in the X and Y directions of the original when bringing it into contact with the substrate. Also, if the distance (to be referred to as the gap hereinafter) between a substrate and original in the Z direction changes, the distance between alignment marks formed on the substrate and original also changes. If a mounting error of a TTM scope has produced telecentricity, a measurement error occurs during TTM scope measurement in accordance with the distance between the alignment marks.

To solve the above-mentioned problem, the relative positions of a substrate and original during TTM scope measurement are desirably set as close as possible to those during the imprint process. However, when the relative positions of a substrate and original during TTM scope measurement are made equal to those during the imprint process, the substrate and original may contact each other, and this may break patterns drawn on the substrate and original.

### SUMMARY OF THE INVENTION

The present invention provides a technique advantageous in performing an imprint process while aligning an original and substrate with a high accuracy.

The present invention in its one aspect provides an imprint apparatus which performs, for each of a plurality of shot regions on a substrate, an imprint process of bringing a resin coated on the substrate into contact with a pattern surface of an original and curing the resin, comprising: an original holder configured to hold the original on which an original mark is formed; a substrate stage configured to hold the substrate on which a substrate mark is formed in each shot region; a first scope configured to measure a position deviation amount between a shot region and the original by detecting the substrate mark and the original mark through the original; a curing unit configured to cure the resin; and a controller, wherein the controller brings the original into contact with the resin coated on each of not less than two shot regions of the plurality of shot regions, which is aligned based on preobtained layout data of the plurality of shot regions, and measures a position deviation amount between each of the not less than two shot regions and the original by using the first scope, calculates a position deviation amount between each of the plurality of shot regions and the original by statistically processing the position deviation amounts measured in the not less than two shot regions, and corrects the layout data of the plurality of shot regions by using the calculated position deviation amounts, and executes the imprint process while aligning each shot region other than the not less than two shot regions with the original based on the corrected layout data.

Further features of the present invention will become apparent from the following description of exemplary embodiments with reference to the attached drawings.

### BRIEF DESCRIPTION OF THE DRAWINGS

FIG. 1 is a view showing an imprint apparatus of the present invention;

FIG. 2 is a flowchart showing the operation of the imprint apparatus according to the first embodiment;

FIGS. 3A to 3C are views showing an imprint process;

FIGS. 4A and 4B are views showing examples of the layouts of TTM scope measurement shots and non-TTM scope measurement shots in the first embodiment;

FIG. 5 is a flowchart showing the operation of an imprint apparatus according to the second embodiment; and

FIGS. 6A to 6C are views showing examples of the layouts of OA scope measurement shots, TTM scope measurement shots, and non-TTM scope measurement shots in the second embodiment.

### DESCRIPTION OF THE EMBODIMENTS

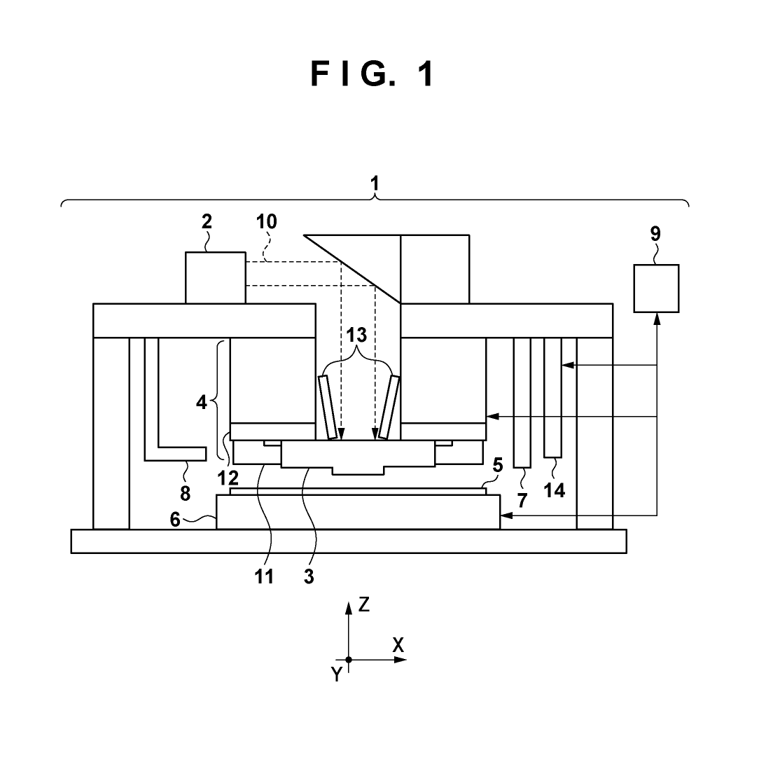

Embodiments of the present invention will be explained below with reference to the accompanying drawings. FIG. 1 is a view showing a configuration example of an imprint apparatus using a photo-curing method. An imprint apparatus 1 is used in, e.g., a semiconductor device fabrication step in which an imprint process of bringing a resin applied on a substrate (wafer) into contact with the pattern surface of an original (also called a mask, mold, or template) and curing the resin is performed on each of a plurality of shot regions of the substrate. Note that an explanation will be made by taking a Z-axis parallel to the axis of ultraviolet irradiation to an original, an X-axis in a direction in which a wafer moves relative to a mask (to be described later) in a plane perpendicular to the Z-axis, and a Y-axis in a direction perpendicular to the X-axis, in the following drawings.

The imprint apparatus 1 includes an illumination system 2, mask (original) 3, mount head 4, wafer (substrate) 5, wafer stage (substrate stage) 6, coating mechanism 7, mask conveyor system 8, controller 9, and OA (Off-Axis) scope 14. The illumination system 2 forms a curing unit that cures a resin by irradiating the mask 3 with ultraviolet light 10 during an imprint process. The illumination system 2 includes a light source, and a plurality of optical elements for adjusting the ultraviolet light emitted from the light source into light appropriate for the imprint process.

The mask 3 is a template on which a predetermined three-dimensional pattern is formed on the surface facing the wafer. The mount head 4 is an original holder for holding and fixing the mask 3. The mount head 4 includes a magnification correction mechanism 11, a mask chuck 12 for attracting and holding the mask 3 by an attracting force or static electricity, and TTM (Through The Mask) scopes 13. The magnification correction mechanism 11 corrects the three-dimensional pattern formed on the mask 3 into a desired shape by applying a pressure to the mask 3.

The TTM scopes 13 are positioned above the mask 3 as they are supported by the mount head 4. Each TTM scope 13 is a scope (first scope) including an optical system and imaging system for observing, through the mask 3, a substrate mark formed in each shot region of the wafer 5, and an original mark formed on the mask 3. In this embodiment, the TTM scopes 13 are supported by the mount head 4. Since the TTM scopes 13 detect the substrate marks and original marks through the mask 3, it is possible to measure position deviation amounts in the X and Y directions between each shot region on the wafer 5 and the mask 3. The OA scope (second scope) 14 is horizontally spaced apart from the mount head 4, and capable of measuring the positions in the X and Y directions of each shot region on the wafer 5 by detecting the substrate marks. The OA scope 14 has spatial limitations fewer than those of the TTM scopes 13, and can have a larger number of process corresponding functions, such as a function of switching the wavelengths of observation light in accordance with a drawn pattern on the wafer 5, than those of the TTM scopes 13.

The mount head 4 includes a mask chuck driving mechanism (not shown) for driving the mask chuck 12. The mask chuck driving mechanism is a driving system for driving the mask chuck 12 in the Z-axis direction, in order to bring the mask 3 into contact with a resin applied on the wafer 5. After the resin is cured, the mask chuck driving mechanism separates the wafer 5 from the mask 3 by driving the mask chuck 12 in the Z direction. A pressing operation of bringing the mask 3 into contact with the resin by pressing the former against the latter and a mold release operation of separating the wafer 5 from the mask 3 may be implemented by driving the mask 3 in the Z direction, and may also be implemented by driving the wafer stage (substrate stage) 6 in the Z direction. The wafer stage 6 is a wafer holding mechanism capable of holding the wafer 5 by vacuum suction, and freely movable in the X-Y plane. The coating mechanism 7 coats the wafer 5 with an uncured resin. The resin is a photo-curing resin that cures when receiving the ultraviolet light 10 from the illumination system 2. The mask conveyor system 8 conveys the mask 3 and places it on the mask chuck 12.

The controller 9 controls the operation of each unit of the imprint apparatus 1, and obtains sensor values and the like. The controller 9 is a computer or sequencer (not shown) connected to each unit of the imprint apparatus 1 by a line, and including a memory. The controller 9 corrects preobtained layout data of a plurality of shot regions by using position deviation amounts between the mask 3 and two or more shot regions measured by the TTM scopes 13, or the positions of two or more shot regions measured by OA scope 14. Based on the corrected layout data, the controller 9 executes the imprint process while aligning each shot region with the mask 3. In this embodiment, the controller 9 is installed in the imprint apparatus 1. However, the controller 9 may also be installed in a place different from the imprint apparatus 1, and perform remote control.

### First Embodiment

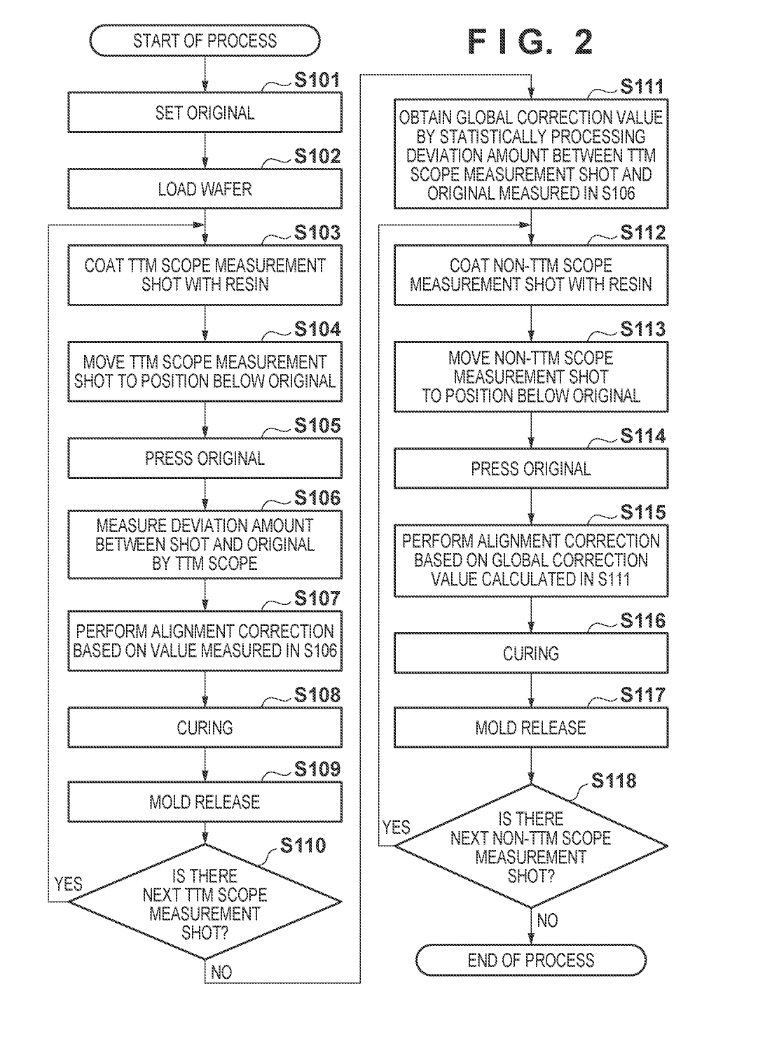

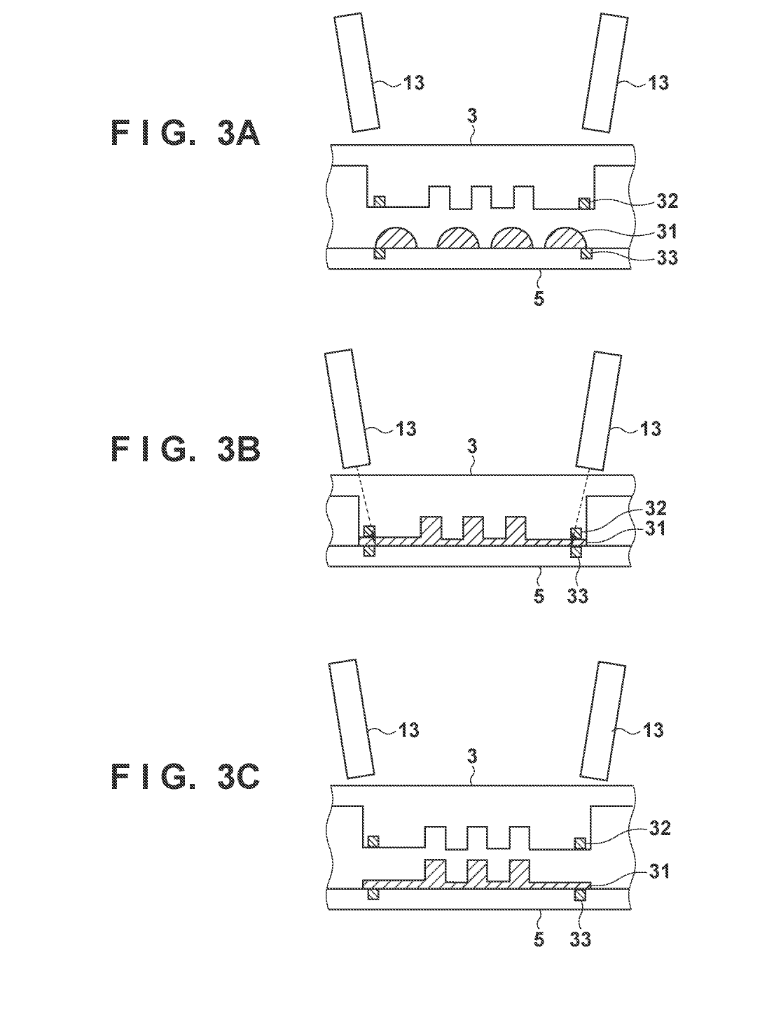

The operation of the imprint apparatus 1 will be explained below with reference to FIG. 2. The controller 9 controls this operation. First, in step S101, the mask 3 is conveyed to the mask chuck 12 and aligned by the mask conveyor system 8, and held by the mask chuck 12. In step S102, the wafer 5 is conveyed to and loaded on the wafer stage 6 by a conveyor mechanism (not shown), and held by a wafer chuck (not shown). In step S103, the controller 9 moves a shot region (measurement shot) to be measured by the TTM scopes 13 to a position below the coating mechanism 7 by driving the wafer stage 6 in the X and Y directions, and coats the measurement shot with a photo-curing resin discharged from the coating mechanism 7. Measurement shots to be measured by the TTM scopes are two or more shot regions of a plurality of shot regions formed on the wafer 5. FIG. 3A is a view showing a resin 31 applied on the wafer 5. The applied resin 31 forms droplets having a height of a few ten μm to a few hundred μm from the upper surface of the wafer 5. Although FIG. 3A shows only four droplets of the photo-curing resin 31, the surface of the wafer 5 is actually coated with a few thousands to a few millions of droplets.

In step S104, the controller 9 drives the wafer stage 6 in the X and Y directions based on preobtained layout data of a plurality of shot regions on the wafer 5, thereby aligning the measurement shot below the mask 3. In step S105, the controller 9 brings the mask 3 into contact with the resin 31 on the wafer 5 by lowering the mask 3. The controller 9 may also bring the mask 3 into contact with the resin 31 by pressing the former against the latter by raising the wafer stage 6, instead of lowering the mask 3. Before the mask 3 is brought into contact the resin 31 forms droplets having a height of a few ten μm to a few thousand μm from the upper surface of the wafer 5. Accordingly, the mask 3 and resin 31 start contacting each other when the gap between the lower surface of the mask 3 and the upper surface of the wafer 5 becomes a few ten μm to a few thousand μm. The load of pressing can be controlled by using, for example, a load sensor (not shown) incorporated into the mount head 4. When pressing the mask 3, the mask 3 and wafer 5 do not directly interfere with each other because the wafer 5 is coated with the resin 31.

In step S106, the controller 9 observes original marks 32 and substrate marks 33 with the TTM scopes 13, and measures a position deviation amount between the two kinds of marks, that is, a position deviation amount between the shot region and mask 3, with the mask 3 being in contact with the resin 31. FIG. 3B shows the way the TTM scopes 13 measure the position deviation amount between the original marks 32 and substrate marks 33, while the mask 3 is in contact with the resin 31. The original marks 32 are formed on the mask 3. On the other hand, the substrate marks 33 are formed on the wafer 5. While the mask 3 is pressed against the resin 31, the gap between the mask 3 and wafer 5 is a few nm to a few hundred nm. Since the gap between the mask 3 and wafer 5 is as small as a few nm to a few hundred nm, it is possible to decrease a measurement error of the position deviation amount obtained by the TTM scopes 13.

In step S107, based on the position deviation amount between the shot region and mask 3 measured in step S106, the controller 9 corrects the relative positions of the shot region and mask 3 by the magnification correction mechanism 11 and wafer stage 6. More specifically, the magnification correction mechanism 11 corrects the shape of the mask 3, and the wafer stage 6 corrects the position of the shot region. Since the position deviation amount between the mask 3 and shot region measured in step S106 changes from one measurement shot to another, alignment correction is performed using different indices for different shot regions, that is, so-called, die-by-die alignment correction is performed. In step S108, the controller 9 irradiates the resin 31 with ultraviolet light through the mask 3 by using the illumination system 2, thereby curing the resin.

In step S109, the controller 9 separates the cured resin 31 from the mask 3 by raising the mask 3. The controller 9 may also separate the mask 3 from the resin 31 by lowering the wafer stage 6, instead of raising the mount head 4. FIG. 3C shows the mask 3, wafer 5, and resin 31 after mold release. After mold release, the photo-cured resin 31 forms a three-dimensional pattern on the wafer 5.

In step S110, the controller 9 determines whether the measurement process and imprint process have been performed on all shot regions. If there is a next measurement shot, the process returns to step S103, and the measurement process and imprint process are performed on the next measurement shot. If there is no next measurement shot, the process advances to step S111. In step S111, the controller 9 statistically processes the position deviation amounts of two or more measurement shots measured in step S106, calculates the position deviation amount of each of the plurality of shot regions with respect to the mask 3, and corrects the shot region layout data by using the calculated position deviation amounts. That is, the controller 9 uses the measurement shots for which the TTM scopes 13 measure the position deviation amounts, as sample shots of the global alignment method.

From step S112, for each shot region (non-measurement shot) other than the two or more shot regions measured by the TTM scopes, the controller 9 executes the imprint process while aligning the shot region with the mask 3 based on the corrected layout data. In step S112, the controller 9 coats the non-measurement shot with the photo-curing resin 31 by using the coating mechanism 7 in the same manner as in step S103. In step S113, the controller 9 moves the non-measurement shot to the position below the mask 3. In step S114, the controller 9 presses the mask 3 against the resin 31 on the wafer 5 in the same manner as in step S105.

In step S115, based on the layout data corrected in step S111, the controller 9 aligns the non-measurement shot with the mask 3 by using the magnification correction mechanism 11 and wafer stage 6. So-called global alignment correction using the same index is performed on the non-measurement shot. In this embodiment, step S115 of aligning the non-measurement shot based on the corrected layout data is performed after the step (S114) of pressing the mask 3 against the resin 31 on the wafer 5. However, it is also possible to switch steps S114 and S115, that is, align the non-measurement shot based on the corrected layout data and then press the mask 3 against the resin 31 on the wafer 5.

In step S116, the illumination system 2 cures the resin 31 on the non-measurement shot in the same way as in step S108. In step S117, the mask 3 is separated from the cured resin 31 in the same way as in step S109. In step S118, the controller 9 determines whether the imprint process has been performed for all non-measurement shots. If there is a next non-measurement shot, the process returns to step S112, and the imprint process is performed on the next non-measurement shot. If there is no next non-measurement shot, the process is terminated.

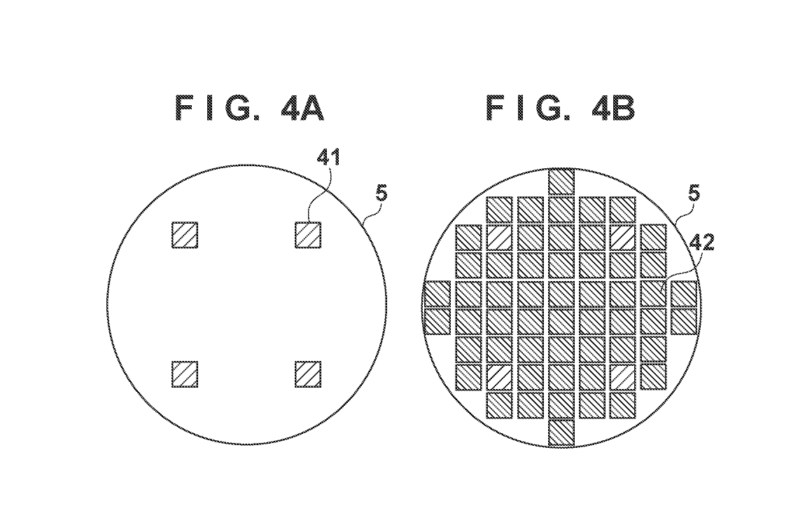

FIG. 4A shows an example of the layout of measurement shots on the wafer 5 to be measured by the TTM scopes. Hatched shot regions 41 on the wafer 5 indicate measurement shots. Both the measurement process and imprint process are performed on the measurement shots 41 in steps S103 to S110. FIG. 4B shows an example of the layout of non-measurement shots on the wafer 5. Solid shot regions 42 indicate non-measurement shots. After the measurement process and imprint process are performed on the measurement shots, the imprint process is performed on the non-measurement shots 42 in steps S112 to S118.

The wafer 5 having undergone the imprint process in the imprint apparatus 1 is tested in a post-process. Since alignment correction using the same index is performed on the non-measurement shots on the wafer 5 based on the global correction value, a sampling test is performed in the post-process. On the other hand, die-by-die alignment correction using different indices is performed on the measurement shots. Therefore, a test different from the sampling test for the non-measurement shots may be conducted on the measurement shots.

### Second Embodiment

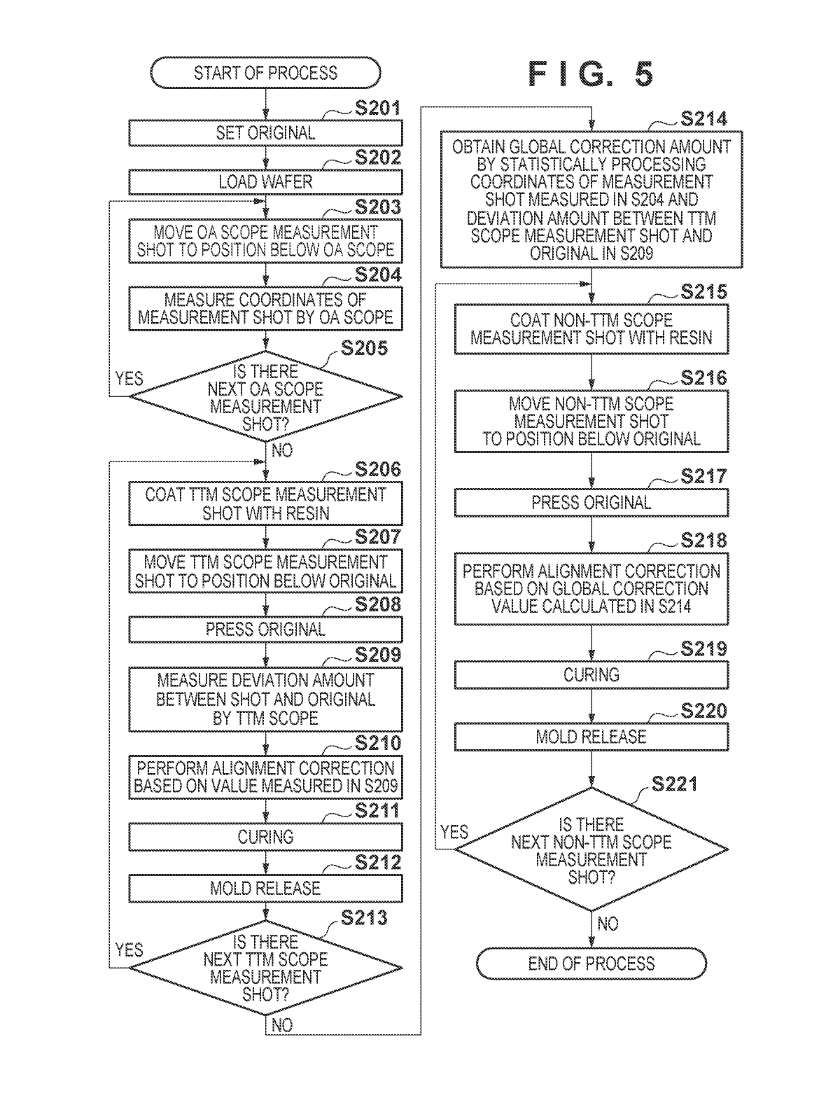

In the second embodiment, the basic procedure of the operation of the imprint apparatus 1 is the same as that of the first embodiment. The difference is that the positions of some shot regions on the wafer 5 are measured using the OA scope 14 in the second embodiment. Details of only this additional feature will be explained in the second embodiment. The operation of the imprint apparatus 1 will be explained below with reference to FIG. 5. The basic operation is the same as that of steps S101 to S118 in the flowchart shown in FIG. 2. Steps S201 and S202 are the same as steps S101 and S102.

In step S203, the controller 9 drives the wafer stage 6 in the X and Y directions based on preobtained layout data of a plurality of shot regions on the wafer 5, thereby moving a shot region to be measured by the OA scope 14 to a position below it. This shot region to be measured by the OA scope 14 will be called an OA scope measurement shot hereinafter. In step S204, the controller 9 measures the positions of the OA scope measurement shot in the X and Y directions by detecting substrate marks by the OA scope 14. Unlike a measurement shot to be measured by the TTM scopes in the first embodiment, the OA scope measurement shot is a shot region that is not coated with a resin when measured.

In step S205, the controller 9 determines whether the measurement process has been performed on all OA scope measurement shots. If there is a next OA scope measurement shot, the process returns to step S203, and the measurement process is performed on the next OA scope measurement shot. If there is no next OA scope measurement shot, the process advances to step 5206. For at least one of the OA scope measurement shots, the measurement process of measuring the position deviation amount between the shot region and mask 3 by using the TTM scopes 13 and the imprint process are performed. Steps S206 to S213 are the same as steps S103 to S110.

In step S214, the controller 9 calculates the position deviation amount of each of a plurality of shot regions by statistically processing the positions of two or more OA scope measurement shots measured in step S204, and corrects the preobtained shot region layout data by using the calculated position deviation amounts. Also, for at least one shot region, the controller 9 calculates a baseline correction amount based on the positions of the shot regions measured by the OA scope 14, and the position deviation amounts between the shot regions and mask 3 measured by the TTM scopes 13. The baseline is the distance between the OA scope 14 and mask 3. Then, the controller 9 calculates a global alignment correction value by adding the baseline correction value to the corrected shot region layout data. That is, the controller 9 uses shot regions to be measured by the TTM scopes 13 as measurement shots for obtaining the baseline correction value, and OA scope measurement shots to be measured by the OA scope 14 as sample shots of the global alignment method.

Steps S215 to S221 in which the imprint process is repetitively performed while performing alignment correction on shot regions other than the shot regions for which the measurement process using the TTM scopes 13 and the imprint process are performed are the same as steps S112 to S118. In this embodiment, step S218 of aligning a non-measurement shot based on the corrected layout data is performed after the step (S217) of pressing the mask 3 against the resin 31 on the wafer 5. However, it is also possible to switch steps S217 and S218, that is, align the non-measurement shot based on the corrected layout data and then press the mask 3 against the resin 31 on the wafer 5.

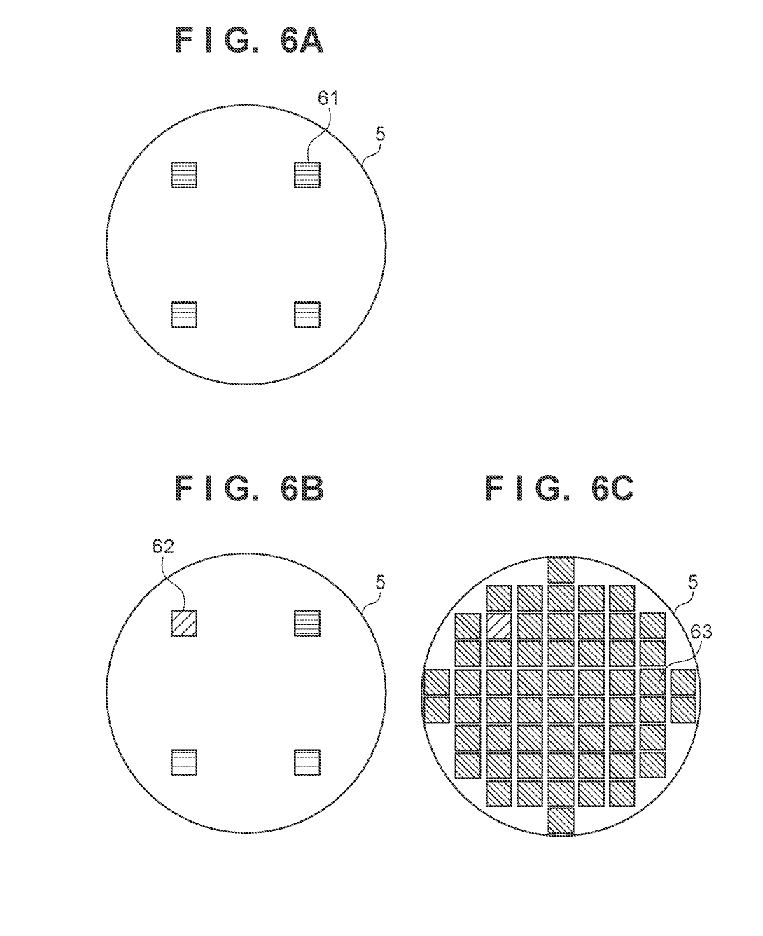

FIG. 6A shows an example of the layout of the OA scope measurement shots on the wafer 5 to be measured by the OA scope 14. Laterally hatched regions 61 on the wafer 5 indicate the OA scope measurement shots. The measurement process in steps S203 to S205 is performed on the OA scope measurement shots 61. FIG. 6B shows an example of the layout of shot regions on the wafer 5 for which the measurement process using the TTM scopes 13 and the imprint process are performed in addition to the measurement process using the OA scope 14. An obliquely hatched shot region 62 on the wafer 5 indicates a shot region for which the measurement process using the TTM scopes 13 is also performed. For the shot region 62 to be measured by the TTM scopes 13, the measurement process using the TTM scopes 13 and the imprint process are performed in steps S206 to S213. Although FIG. 6B shows one shot region 62 to be measured by the TTM scopes 13, a plurality of shot regions 62 may also exist.

FIG. 6C shows an example of the layout of non-TTM scope measurement shots on the wafer 5, which are not measured by the TTM scopes 13. Solid shots 63 on the wafer 5 indicate the non-TTM scope measurement shots. After the measurement process and imprint process are performed on the shot 62, the imprint process is performed on the non-TTM scope measurement shots 63 in steps S215 to S221. As in the first embodiment, the wafer 5 having undergone the imprint process is tested in a post-process.

As described above, with the gap between the wafer 5 and mask 3 being narrowed while interference between them is avoided by applying the resin 31, the position deviation amounts between the wafer 5 and mask 3 are measured by the TTM scopes 13, and a global alignment correction value is calculated by using the measurement results. This makes it possible to perform alignment correction by the global alignment method while decreasing measurement errors caused by the TTM scopes 13 in the imprint apparatus 1.

[Method of Manufacturing Article]

A method of manufacturing a device (for example, a semiconductor integrated circuit device or liquid crystal display device) as an article includes a step of transferring (forming) a pattern onto a substrate (wafer, glass plate, or film-like substrate) by using the imprint apparatus 1 described above. This manufacturing method can further include a step of etching the substrate having the transferred pattern. Note that when manufacturing another article such as a patterned medium (recording medium) or optical device, the manufacturing method can include another step of processing the substrate having the transferred pattern, instead of etching.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-040840 filed Feb. 25, 2011, which is hereby incorporated by reference herein in its entirety.

What is claimed is:

1. An imprint apparatus which performs, for each of a plurality of shot regions on a substrate, an imprint process of bringing a resin coated on the substrate into contact with a pattern surface of an original and curing the resin, comprising:
an original holder configured to hold the original on which an original mark is formed;
a substrate stage configured to hold the substrate on which a substrate mark is formed in each shot region;
a first scope configured to measure a position deviation amount between a shot region and the original by detecting the substrate mark and the original mark through the original;
a curing unit configured to cure the resin; and
a controller,
wherein said controller brings the original into contact with the resin coated on each of not less than two shot regions of the plurality of shot regions, which is aligned based on preobtained layout data of the plurality of shot regions, and measures a position deviation amount between each of the not less than two shot regions and the original by using said first scope,
calculates a position deviation amount between each of the plurality of shot regions and the original by statistically processing the position deviation amounts measured in the not less than two shot regions, and corrects the layout data of the plurality of shot regions by using the calculated position deviation amounts, and
executes the imprint process while aligning each shot region other than the not less than two shot regions with the original based on the corrected layout data.

2. An imprint apparatus which performs, for each of a plurality of shot regions on a substrate, an imprint process of bringing a resin coated on the substrate into contact with a pattern surface of an original and curing the resin, comprising:
an original holder configured to hold the original on which an original mark is formed;
a substrate stage configured to hold the substrate on which a substrate mark is formed in each shot region;
a first scope configured to measure a position deviation amount between a shot region and the original by detecting the substrate mark and the original mark through the original;
a second scope positioned horizontally away from said original holder, and configured to measure a position of a shot region by detecting the substrate mark;
a curing unit configured to cure the resin; and
a controller,
wherein said controller causes said second scope to detect the substrate mark on each of not less than two shot regions of the plurality of shot regions, which is aligned based on preobtained layout data of the plurality of shot regions and is not coated with the resin, thereby measuring a position of each of the not less than two shot regions,
brings the original into contact with the resin coating at least one of the not less than two shot regions, which is aligned based on the layout data, and measures a position deviation amount between the shot region and the original by using said first scope,
calculates a position deviation amount of each of the plurality of shot regions by statistically processing positions of the not less than two measured shot regions, and corrects the layout data by using the calculated position deviation amounts,
calculates a correction value of a baseline of said second scope, which is a distance between said second scope and the original, based on the position of the at least one shot region measured by said second scope, and the position deviation amount measured by said first scope, and
executes the imprint process while aligning each shot region other than the at least one shot region with the original based on the corrected layout data and the calculated baseline correction value.

3. The apparatus according to claim 1, wherein said controller corrects relative positions of the original and each of the not less two shot regions based on the measured position deviation amount, and causes said curing unit to cure the resin.

4. The apparatus according to claim 2, wherein said controller corrects relative positions of the at least one shot region and the original based on the measured position deviation amount, and causes said curing unit to cure the resin.

5. A method of manufacturing an article, the method comprising steps of:
forming a pattern on a substrate using an imprint apparatus; and
processing the substrate having the pattern formed thereon in the step of forming,
wherein the imprint apparatus comprises:
an original holder configured to hold an original on which an original mark is formed;
a substrate stage configured to hold the substrate on which a substrate mark is formed in each shot region;
a first scope configured to measure a position deviation amount between a shot region and the original by detecting the substrate mark and the original mark through the original;
a curing unit configured to cure the resin; and
a controller, and
the controller brings the original into contact with the resin coated on each of not less than two shot regions of the plurality of shot regions, which is aligned based on preobtained layout data of the plurality of shot regions, and measures a position deviation amount between each of the not less than two shot region and the original by using the first scope,
calculates a position deviation amount between each of the plurality of shot regions and the original by statistically processing the position deviation amounts measured in the not less than two shot regions, and corrects the layout data of the plurality of shot regions by using the calculated position deviation amounts, and
executes the imprint process while aligning each shot region other than the not less than two shot regions with the original based on the corrected layout data.

6. A method of manufacturing an article, the method comprising steps of:
forming a pattern on a substrate using an imprint apparatus; and
processing the substrate having the pattern formed thereon in the step of forming,
wherein the imprint apparatus comprises:
an original holder configured to hold an original on which an original mark is formed;
a substrate stage configured to hold the substrate on which a substrate mark is formed in each shot region;
a first scope configured to measure a position deviation amount between a shot region and the original by detecting the substrate mark and the original mark through the original;
a second scope positioned horizontally away from the original holder, and configured to measure a position of a shot region by detecting the substrate mark;
a curing unit configured to cure the resin; and
a controller, and
the controller causes the second scope to detect the substrate mark on each of not less than two shot regions of the plurality of shot regions, which is aligned based on preobtained layout data of the plurality of shot regions and is not coated with the resin, thereby measuring a position of each of the not less than two shot regions,
brings the original into contact with the resin coated on at least one of the not less than two shot regions, which is aligned based on the layout data, and measures a position deviation amount between the at least one shot region and the original by using the first scope,
calculates a position deviation amount of each of the plurality of shot regions by statistically processing positions of the not less than two measured shot regions, and corrects the layout data by using the calculated position deviation amounts,
calculates a correction value of a baseline of the second scope, which is a distance between the second scope and the original, based on the position of the at least one shot region measured by the second scope, and the position deviation amount measured by the first scope, and
executes the imprint process while aligning each shot region other than the at least one shot region with the original based on the corrected layout data and the calculated baseline correction value.
